(19) United States
(12) Patent Application Publication
(10) Pub. No.: US 2014/0184943 A1
(43) Pub. Date: Jul. 3, 2014

(54) 3D TOUCH CONTROL LIQUID CRYSTAL LENS GRATING, METHOD FOR MANUFACTURING THE SAME AND 3D TOUCH CONTROL DISPLAY DEVICE

(71) Applicant: BEIJING BOE OPTOELECTRONICS TECHNOLOGY CO., LTD., Beijing (CN)

(72) Inventors: Shengji Yang, Beijing (CN); Yingming Liu, Beijing (CN); Haisheng Wang, Beijing (CN); Junwei Wu, Beijing (CN)

(73) Assignee: BEIJING BOE OPTOELECTRONICS TECHNOLOGY CO., LTD., Beijing (CN)

(21) Appl. No.: 13/995,723

(22) PCT Filed: Dec. 12, 2012
(86) PCT No.: PCT/CN2012/086390

§ 371 Date: Jun. 19, 2013

(30) Foreign Application Priority Data
May 3, 2012 (CN) 201210134898.2

(51) Int. Cl. G02F 1/1333; G02F 1/1341; G02B 27/22

(52) U.S. Cl. CPC G02F 1/13338; G02B 27/2214; G02F 1/1341
USPC 349/12; 349/15; 29/832

(57) ABSTRACT

There are provided a 3D touch control liquid crystal lens grating, a manufacturing method thereof and a 3D touch control display device. The 3D touch control liquid crystal lens grating comprises: a lower substrate, including a lower transparent substrate and a plane electrode formed on the lower transparent substrate; an upper substrate, which is cell-assembled with the lower substrate and includes an upper transparent substrate and strip-shaped electrodes formed on the upper transparent substrate; and liquid crystal, filled between the plane electrode and the strip-shaped electrodes, wherein at least one touch control electrode is disposed between the upper transparent substrate and the strip-shaped electrodes, and a transparent spacer layer is disposed between the touch control electrode and the strip-shaped electrodes.

### BACKGROUND

Embodiments of the present invention relate to a 3D touch control liquid crystal lens grating, a method for manufacturing the same and a 3D touch control display device.

With the development of display technology, a 3D (three dimensional) display device having an effect of stereoscopic display and a touch screen in support of touch control are increasingly in popularity among consumers. An integrated product which has two functions of 3D display and touch control gets people's attention increasingly.

Currently, a display device which has two functions of 3D display and touch control is usually obtained by an overlapping method, that is, a two-layered electrode for touch control is additionally manufactured over a formed 3D display device after a cell assembly process. Regarding the 3D touch control display device with such a structure, when it is compared with a conventional 3D display device, an overall thickness of the display device is larger. An overlarge cell thickness not only affects the 3D display effect of the display device, but also makes fabrication of the display device more complex, thereby increasing the production cost.

### SUMMARY

According to embodiments of the invention, there are provided a 3D touch control liquid crystal lens grating, a method for manufacturing the same and a 3D touch control display device, capable of decreasing thickness of the 3D touch control display device and reducing production cost of the product.

In an aspect of an embodiment of the present invention, there is provided a 3D touch control liquid crystal lens grating, comprising: a lower substrate, including a lower transparent substrate and a plane electrode formed on the lower transparent substrate; an upper substrate, which is cell-assembled with the lower substrate and includes an upper transparent substrate and strip-shaped electrodes formed on the upper transparent substrate; and liquid crystal filled between the plane electrode and the strip-shaped electrodes, wherein at least one touch control electrode is disposed between the upper transparent substrate and the strip-shaped electrodes, and a transparent spacer layer is disposed between the touch control electrode and the strip-shaped electrodes.

In another aspect of an the embodiment of the invention, there is provided a 3D touch control display device, comprising: a display panel; a liquid crystal lens grating (being the above liquid crystal lens grating) adhered to a light emitting side of the display panel, wherein the upper substrate with the strip-shaped electrodes formed is farther from the display panel compared to the lower substrate with the plane electrode formed.

In another aspect of an embodiment of the invention, there is provided a method for manufacturing a 3D touch control liquid crystal lens grating, comprising: forming a plane electrode on a lower transparent substrate, so as to obtain a lower substrate; sequentially forming at least one touch control electrode, a transparent spacer layer and strip-shaped electrodes on an upper transparent substrate, so as to obtain an upper substrate; and cell-assembling the upper substrate with the lower substrate to form a cell and filling liquid crystal in the cell, so as to form the liquid crystal lens grating.

Regarding the 3D touch control liquid crystal lens grating, the method for manufacturing the same and the 3D touch control display device, by means of disposing the touch control electrode between the strip-shaped electrodes and the upper transparent substrate inside the liquid crystal lens grating, and locating the transparent spacer layer between the touch control electrode and the strip-shaped electrodes, while the plane electrode of the lower substrate and the strip-shaped electrodes of the upper substrate form the liquid crystal lens grating, the strip-shaped electrodes that form the liquid crystal lens grating by driving liquid crystal to deflect function as another driving electrode of a touch screen at the same time, so that the strip-shaped electrodes form the touch screen together with the touch control electrode while the 3D display effect is guaranteed by it. In such a way, a two-layered electrode for touch control in prior art can be changed to a single-layered electrode, so as to decrease thickness of the 3D touch control display device, simplify the manufacturing procedure, and reduce the production cost of the product.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematically cross-sectional view showing a structure of a 3D touch control liquid crystal lens grating provided by an embodiment of the invention;

FIG. 2 is a top view showing a plane electrode and strip-shaped electrodes of the 3D touch control liquid crystal lens grating provided by an embodiment of the invention;

FIG. 3 is a schematic view showing internal wires of the 3D touch control liquid crystal lens grating provided by an embodiment of the invention;

FIG. 4 is a schematic view showing the principle of operation of the 3D touch control liquid crystal lens grating provided by an embodiment of the invention;

FIG. 5 is a schematically cross-sectional view showing a structure of a 3D touch control display device provided by an embodiment of the invention.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

A 3D touch control liquid crystal lens grating is provided by an embodiment of the invention. As shown in FIG. 1, the 3D touch control liquid crystal lens grating 11 comprises:

a lower substrate 12 and an upper substrate 13 which are bonded to each other by a cell assembly process, the lower substrate 12 including a lower transparent substrate 121 and a plane electrode 122, the upper substrate 13 including an upper transparent substrate 131 and strip-shaped electrodes 132. liquid crystal being filled between the plane electrode 122 and the strip-shaped electrodes 132. At least one touch control electrode 133 is disposed between the upper transparent substrate 131 and the strip-shaped electrodes 132, and a transparent spacer layer 134 is located between the touch control electrode 133 and the strip-shaped electrodes 132.

Optionally, there are two or more touch control electrodes 133 arranged adjacent to each other, and a space is formed between any two adjacent touch control electrodes 133.

With such a 3D touch control liquid crystal lens grating, the touch control electrode is disposed between the strip-shaped electrodes and the upper transparent substrate inside the liquid crystal lens grating, and between the touch control electrode and the strip-shaped electrodes is the transparent spacer layer. While the plane electrode of the lower substrate and the strip-shaped electrodes of the upper substrate are used to form the liquid crystal lens grating, the strip-shaped electrodes for driving the liquid crystal to deflect function as another driving electrode of a touch screen at the same time, so that the strip-shaped electrodes form the touch screen together with the touch control electrode while the 3D display effect is guaranteed by it. In such a way, a two-layered electrode for touch control in prior art can be changed to a single-layered electrode, so as to decrease thickness of the 3D touch control display device, simplify the manufacturing procedure, and reduce the production cost of the product.

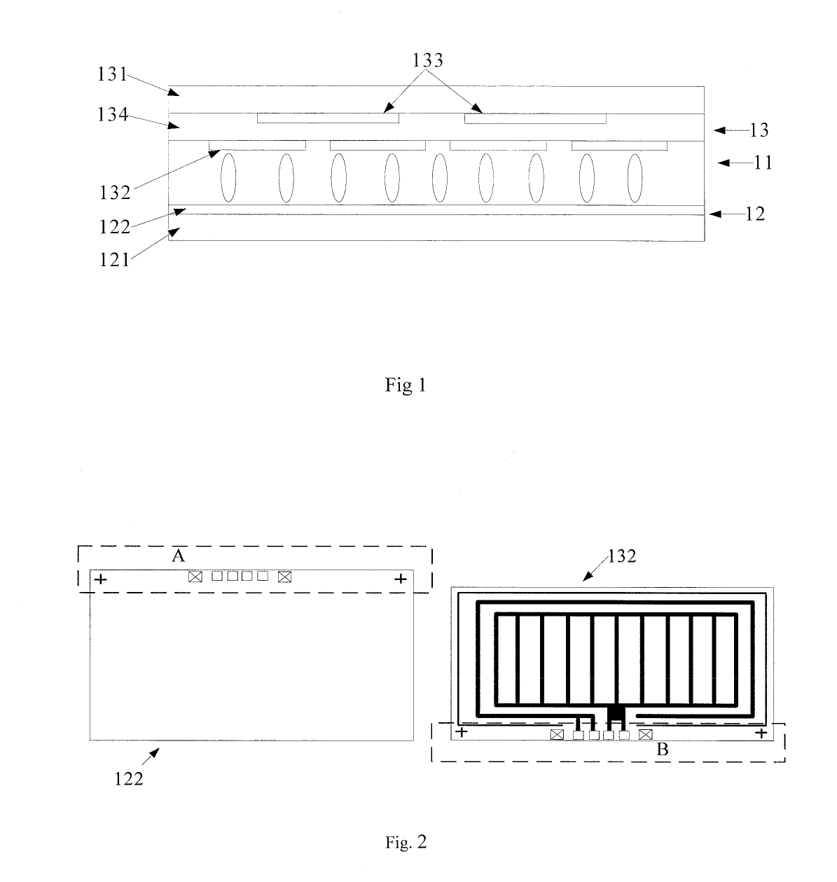

Optionally, the following example scheme may be adopted in the 3D touch control liquid crystal lens grating provided by the embodiment of the invention, that is: at edges on opposite sides of the plane electrode 122 and a region where the strip-shaped electrodes 132 are located, there are identical patterns formed through the same mask which include an external pin bonding part and an alignment mark. As shown in FIG. 2, a pattern as denoted by a region ‘B’ in FIG. 2 is formed through a mask at a lower edge of the region where the strip-shaped electrodes 132 are located, in which, the pattern at the center is an external pin bonding part, and the marks at two ends thereof are alignment marks. Likewise, an identical pattern is formed at a lower edge of the plane electrode 122 through the same mask, and the difference lies in that, for positioning and cell-assembling, the plane electrode 122 needs to be rotated by 180° after it is patterned, so the case is that there is a pattern at an upper edge of the plane electrode 122 which is the same as that at the lower edge of the region where the strip-shaped electrodes 132 are located. Thus, the pattern as denoted by a region ‘A’ in FIG. 2 is obtained. As it is unnecessary for the plane electrode to be connected externally to a pin and the external pin bonding part of the plane electrode serves no function, the plane electrode 122 can be precisely cell-assembled with the upper substrate through the alignment marks at two ends thereof, thereby ensuring quality of the product. As compared to prior art, two masks which are useful for respectively manufacturing an alignment mark of the plane electrode and an external pin bonding part of the strip-shaped electrodes, can be reduced to be one mask, so that fabrication of one mask is omitted, and the production cost is remarkably saved.

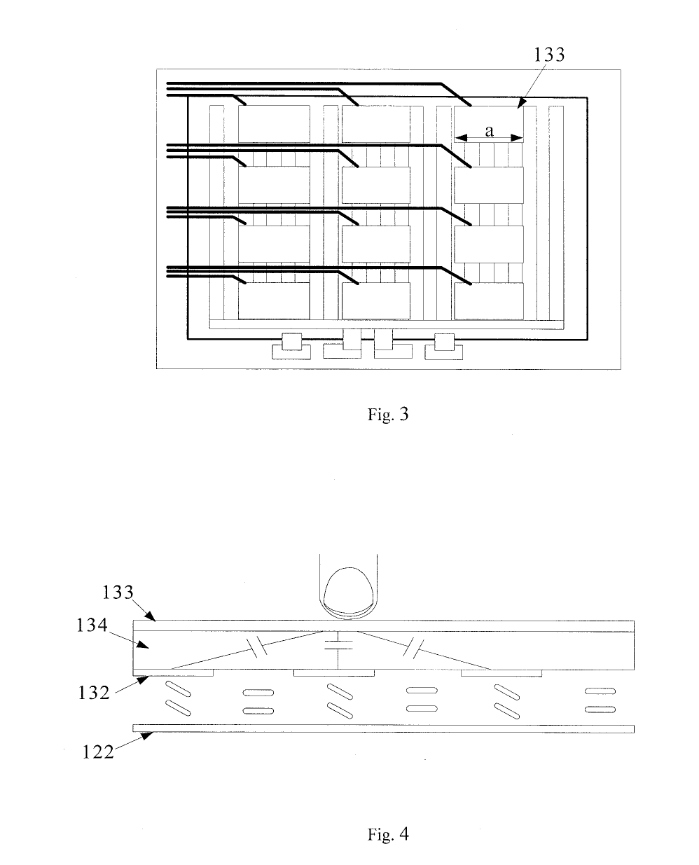

Optionally, as shown in FIG. 3, the following scheme may also be adopted in the 3D touch control liquid crystal lens grating provided by the embodiment of the invention, that is: each touch control electrode 133 adopts an internal wire (that is, a wire is disposed in a display area of a touch control panel, for example, between every two touch control electrodes 133 or around each touch control electrode 133) to gather a touch control signal.

Exemplarily, a touch control electrode in prior art mostly adopts an external wire to gather a touch control signal, a column of touch control electrodes is externally connected to a set of wires, and the number of external wires arranged at a frame of a display device is increased as the column number of the touch control electrodes is increased. When the number of the touch control electrodes is larger, the frame of the display device will become wider, so that appearance of the product is affected and the production cost is increased. When the touch control electrode adopts an internal wire to gather a touch control signal, the size of a glass substrate for a display device can be reduced without affecting its appearance, and width of a frame of the display device is reduced. Because the size of the glass substrate for the display device is reduced, a whole piece of glass substrate can be divided into more small-sized glass substrates for display devices, and the cutting efficiency of the glass substrate is largely enhanced. Thus, the production cost of the product is reduced.

Optionally, the transparent spacer layer 134 may be of a transparent insulating material or a transparent resistance material.

Exemplarily, when the transparent spacer layer 134 is of the transparent insulating material, the touch screen has a capacitive structure. As shown in FIG. 4 (the upper transparent substrate 131 is not shown in the figure), an induced electric field is formed between the touch control electrode 133 and the strip-shaped electrodes 132. When a finger touches a surface of the touch screen, coupling capacitances between the touch control electrode 133 and the strip-shaped electrodes 132 will change, and in turn, induced charges on the touch control electrode may change, and a touch position of the finger can be determined by a processing equipment by means of processing the strength of an electric signal obtained by statistics. When the transparent spacer layer 134 is of the transparent resistance material, the touch screen has a resistive structure, and the transparent resistance material functions as a piezoresistor. When a finger touches a surface of the touch screen, change in resistance at a touch position of the finger may lead to change in current at this position, and the touch position of the finger can be determined by a processing equipment by means of processing the strength of an electric signal obtained by statistics.

With the 3D touch control display device having such a structure, the touch control position is detected by detecting the induced charges on the touch screen, where the detection mode is a mode of receiving on all occasions rather than a mode of sending on an occasion and receiving on an occasion, so that detecting speed of the system is largely increased.

In the embodiment of the invention, shape of the touch control electrode 133 can be determined according to shape of the liquid crystal lens grating or practical requirements of use. For example, the touch control electrode 133 may take the shape of a circle, trapezoid or diamond, or may be shown in an irregular shape according to the shape of the display.

Exemplarily, as shown in FIG. 3, the touch control electrode 133 may be shaped in a rectangle, and a long side of the touch control electrode 133 is less than or equal to 6 millimeters. As a current display device mostly is shaped in a rectangle, the rectangular shape of the touch control electrode 133 can largely reduce the area of a clearance region when a large number of touch control electrodes 133 are closely arranged in a plane, so that a touch control blind zone can be avoided from generating.

It is to be noted that, the surface area of the touch control electrode is decreased as its size decreases. As shown in FIG. 4, when a user's finger touches the touch screen, for a touch point of the finger, a touch control electrode with a smaller surface area can provide more reference signals, and the touch point of the user's finger can be positioned more precisely by analyzing the more reference signals. Thus, the precision of touch control recognition can be enhanced. However, in a touch screen with the same area, reduction of the area of the touch control electrode will result in increasing of the number of touch control electrodes, and arrangement of wires for the touch control electrodes will also become more complex, to thereby result in ascending of production cost of the product. Considering that the surface area of a person's finger (which refers to area of the finger in contact with the touch screen upon touch) is approximately within 6×6 mm², a long side of the touch control electrode 133 can therefore be fabricated to be less than or equal to 6 millimeters. For example, size of the touch control electrode 133 is 5.5×5.5 mm² (being a square). As such a size of the touch control electrode is smaller than the surface area of the finger, it is possible that a touch point of the same size as the surface area of the finger is ensured to be recognized. As such, ascending of cost of the product is restrained and meanwhile, a high precision recognition of the touch screen is guaranteed.

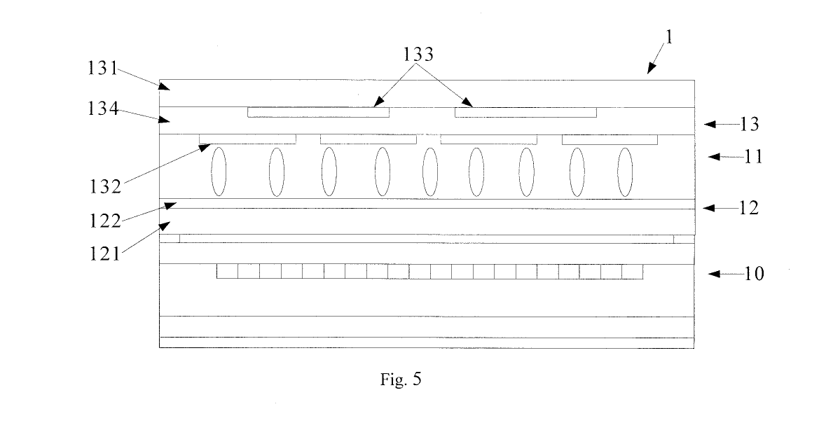

On the other hand, according to an embodiment of the invention, there is further provided a 3D touch control display device 1, as shown in FIG. 5, comprising:

A display panel 10; and a liquid crystal lens grating 11 adhered to a light emitting side of the display panel 10. The liquid crystal lens grating 11 comprises: a lower substrate 12 and an upper substrate 13 which are bonded to each other by a cell assembly process, the lower substrate 12 including a lower transparent substrate 121 and a plane electrode 122, the upper substrate 13 including an upper transparent substrate 131 and strip-shaped electrodes 132, liquid crystal being filled between the plane electrode 122 and the strip-shaped electrodes 132, wherein the upper substrate 13 with the strip-shaped electrodes 132 formed is farther from the display panel 10 compared to the lower substrate with the plane electrode 122 formed. At least one touch control electrode 133 is disposed between the upper transparent substrate 131 and the strip-shaped electrodes 132, and between the touch control electrode 133 and the strip-shaped electrodes 132 is a transparent spacer layer 134. The liquid crystal lens grating 11 may be any of liquid crystal lens gratings as stated by the aforesaid embodiments.

It is to be noted that, the display panel 10 may include a LCD display panel or an organic electroluminescence (OLED) display panel, and may also be an electronic paper panel or other display panel.

Exemplarily, if the display panel 10 is the LCD display panel, then in the display panel 10, a TFT array substrate and a counter substrate are disposed opposite each other so as to form a liquid crystal cell with liquid crystal material filled therein. The counter substrate is such as a color filter substrate. A pixel electrode for each of pixel units of the TFT array substrate acts to apply an electric field for controlling the degree of rotation of liquid crystal material, to thereby perform a display operation. In some examples, the liquid crystal display panel further includes a backlight source for providing the array substrate with backlight.

Another example of the display panel 10 is the organic electroluminescence display device, in which, a pixel electrode for each of pixel units of the TFT array substrate functions as an anode or a cathode for driving an organic light emitting material to emit light, so as to perform a display operation.

Regarding the 3D touch control display device provided by the embodiment of the invention, because the 3D touch control liquid crystal lens grating having such a structure is provided, the touch control electrode is disposed between the strip-shaped electrodes and the upper transparent substrate inside the liquid crystal lens grating, and between the touch control electrode and the strip-shaped electrodes is the transparent spacer layer, while the plane electrode of the lower substrate and the strip-shaped electrodes of the upper substrate are used to form the liquid crystal lens grating, the strip-shaped electrodes that form the liquid crystal lens grating by driving liquid crystal to deflect function as another driving electrode of a touch screen at the same time, and accordingly, the strip-shaped electrodes form the touch screen together with the touch control electrode while the 3D display effect is guaranteed by it. In such a way, a two-layered electrode for touch control in prior art can be changed to a single-layered electrode, so as to decrease thickness of the 3D touch control display device, simplify the manufacturing procedure, and reduce the production cost of the product.

According to another embodiment of the invention, there is provided a method for manufacturing a 3D touch control liquid crystal lens grating, comprising:

S601, a plane electrode is formed on a lower transparent substrate, so as to obtain a lower substrate.

For example, the lower transparent substrate may be a glass substrate, a plastic substrate, or the like. and the plane electrode is formed on the lower transparent substrate by sputtering a transparent conductive material, such as Indium Tin Oxide (ITO) material.

S602, at least one touch control electrode, a transparent spacer layer and strip-shaped electrodes are sequentially formed on an upper transparent substrate, so as to obtain an upper substrate.

The upper transparent substrate may be a glass substrate, a plastic substrate, or the like, and the touch control electrode, the transparent spacer layer and the strip-shaped electrodes can be formed on the upper transparent substrate in sequence by, for example, sputtering, etc.

S603, the upper substrate and the lower substrate are bonded to each other by a cell assembly process to form a cell and liquid crystal is filled in the cell, so as to form the liquid crystal lens grating.

Specifically, the strip-shaped electrode side of the upper substrate and the plane electrode side of the lower substrate are cell-assembled with each other so as to form the liquid crystal lens grating. Wherein, over the plane electrode and the strip-shaped electrodes, there is further foamed a liquid crystal alignment film, and liquid crystal molecules are arranged depending on an alignment direction thereof.

With such a method for manufacturing the 3D touch control liquid crystal lens grating, by means of disposing the touch control electrode between the strip-shaped electrodes and the upper transparent substrate inside the liquid crystal lens grating, and locating the transparent spacer layer between the touch control electrode and the strip-shaped electrodes, while the plane electrode of the lower substrate and the strip-shaped electrodes of the upper substrate form the liquid crystal lens grating, the strip-shaped electrodes that form the liquid crystal lens grating by driving liquid crystal to deflect function as another driving electrode of a touch screen at the same time, so that the strip-shaped electrodes form the touch screen together with the touch control electrode while the 3D display effect is guaranteed by it. In such a way, a two-layered electrode for touch control in prior art can be changed to a single-layered electrode, so as to decrease thickness of the 3D touch control display device, simplify the manufacturing procedure, and reduce the production cost of the product.

Optionally, at edges on opposite sides of the plane electrode and a region where the strip-shaped electrodes are located, there are identical patterns formed through the same mask which include an external pin bonding part and an alignment mark. As shown in FIG. 2, a pattern as denoted by a region ‘B’ in FIG. 2 is formed through a mask at a lower edge of the region where the strip-shaped electrodes 132 are located, in which, the pattern at the center is an external pin bonding part, and the marks at two ends are alignment marks. Likewise, an identical pattern is formed at a lower edge of the plane electrode 122 through the same mask, and the difference lies in that, for positioning and cell-assembling, the plane electrode 122 needs to be rotated by 180° after it is patterned, so the case is that there is a pattern at an upper edge of the plane electrode 122 which is the same as that at the lower edge of the region where the strip-shaped electrodes 132 are located. Thus, the pattern as denoted by a region ‘A’ in FIG. 2 is obtained. As it is unnecessary for the plane electrode to be connected externally to a pin and the external pin bonding part serves no function, the plane electrode 122 can be precisely cell-assembled with the upper substrate through the alignment marks at two ends thereof, thereby ensuring quality of the product. As compared to prior art, two masks which are useful for respectively manufacturing an alignment mark of the plane electrode and an external pin bonding part of the strip-shaped electrodes, can be reduced to be one mask, so that fabrication of one mask is omitted, and production cost is remarkably saved.

Optionally, each touch control electrode adopts an internal wire to gather a touch control signal.

Specifically, a touch control electrode in prior art mostly adopts an external wire to gather a touch control signal. As shown in FIG. 4, a column of touch control electrodes is externally connected to a set of wires, and the number of external wires arranged at a frame of a display device is increased as the column number of the touch control electrodes is increased. When the number of the touch control electrodes is larger, the frame of the display device will become wider, so that appearance of the product is affected and production cost is increased. When a touch control electrode adopts such an internal wire to gather the touch control signal, it is possible that the width of a frame for the display device is reduced without affecting its appearance, so as to reduce the production cost of the product.

In addition, the transparent spacer layer may be of a transparent insulating material or a transparent resistance material.

Specifically, when the transparent spacer layer is of the transparent insulating material, the touch screen has a capacitive structure, and an induced electric field is formed between the touch control electrode and the strip-shaped electrodes. When a finger touches a surface of the touch screen, induced charges on the touch control electrode will change, and touch position of the finger can be determined by a processing equipment by means of processing the strength of an electric signal obtained by statistics. When the transparent spacer layer is of the transparent resistance material, the touch screen has a resistive structure, and the transparent resistive material functions as a piezoresistor. When a finger touches a surface of the touch screen, change in resistance at the touch position of the finger will lead to change in current at this position, and the touch position of the finger can be determined by a processing equipment by means of processing the strength of an electric signal obtained by statistics.

With the 3D touch control liquid crystal lens grating having such a structure, the touch control position is detected by detecting induced charges on the touch screen, where a detection mode is a mode of receiving on all occasions rather than a mode of sending on an occasion and receiving on an occasion, so that detecting speed of the system is largely increased.

In the embodiment of the invention, shape of the touch control electrode can be determined according to shape of the liquid crystal lens grating or practical requirements of use. For example, the touch control electrode may take the shape of a circle, trapezoid or diamond, or may be shown in an irregular shape according to the shape of the display.

Exemplarily, the touch control electrode may be shaped in a rectangle, and a long side of the touch control electrode is less than or equal to 6 millimeters. As a current display device mostly is shaped in a rectangle, the rectangular shape of the touch control electrode can largely reduce the area of a clearance region when a large number of touch control electrodes are closely arranged in a plane, so that a touch control blind zone can be avoided from generating.

It is to be noted that, the surface area of the touch control electrode is decreased as its size decreases. As shown in FIG. 4, when a user's finger touches the touch screen, for a touch point of the finger, a touch control electrode with a smaller surface area can provide more reference signals, and the touch point of the user's finger can be positioned more precisely by analyzing the more reference signals. Thus, the precision of touch control recognition can be enhanced. However, in a touch screen with the same area, reduction of the area of the touch control electrode will result in increasing of the number of touch control electrodes, and arrangement of wires for the touch control electrodes will also become more complex, to thereby result in ascending of production cost of the product. Considering that the surface area of a person's finger (which refers to area of the finger in contact with the touch screen upon touch) is approximately within 6×6 mm², a long side of the touch control electrode 133 can therefore be fabricated to be less than or equal to 6 millimeters. For example, size of the touch control electrode 133 is 5.5×5.5 mm² (being a square). As such a size of the touch control electrode is smaller than the surface area of the finger, it is possible that a touch point of the same size as the surface area of the finger is ensured to be recognized. As such, ascending of cost of the product is restrained and meanwhile, a high precision recognition of the touch screen is guaranteed.

According to still another embodiment of the invention, there is further provided a method for manufacturing a 3D touch control display device, which comprises the steps (steps S601 to S603) of manufacturing a liquid crystal lens grating according to the above method for manufacturing the 3D touch control liquid crystal lens grating, and besides, further comprises:

S604, the liquid crystal lens grating is adhered to a display panel.

Wherein, the liquid crystal lens grating 11 is adhered to a light emitting side of the display panel 10, and the upper substrate 13 with the strip-shaped electrodes 132 formed is farther from the display panel 10 compared to the lower substrate with the plane electrode 122 formed.

It is to be noted that, the display panel may include a LCD display panel, an OLED display panel, an electronic paper panel or other display panel.

Regarding the method for manufacturing the 3D touch control display device, by means of disposing the touch control electrode between the strip-shaped electrodes and the upper transparent substrate inside the liquid crystal lens grating, and locating the transparent spacer layer between the touch control electrode and the strip-shaped electrodes, while the plane electrode of the lower substrate and the strip-shaped electrodes of the upper substrate form the liquid crystal lens grating, the strip-shaped electrodes that form the liquid crystal lens grating by driving liquid crystals to deflect function as another driving electrode of a touch screen at the same time, so that the strip-shaped electrodes form the touch screen together with the touch control electrode while the 3D display effect is guaranteed by it. In such a way, a two-layered electrode for touch control in prior art can be changed to a single-layered electrode, so as to decrease thickness of the 3D touch control display device, simplify the manufacturing procedure, and reduce the production cost of the product.

It should be understood by those skilled in the art that various changes and modifications may be made in these embodiments without departing from the scope and spirit of the present invention. If these changes and modifications fall into the range of the claims and their equivalents, the present invention also is directed to include these changes and modifications.

1. A 3D touch control liquid crystal lens grating, comprising:
a lower substrate, including:
a lower transparent substrate; and
a plane electrode, formed on the lower transparent substrate;
an upper substrate, which is cell-assembled with the lower substrate and includes:
an upper transparent substrate; and
strip-shaped electrodes, formed on the upper transparent substrate;
liquid crystal, filled between the plane electrode and the strip-shaped electrodes, wherein at least one touch control electrode is disposed between the upper transparent substrate and the strip-shaped electrodes, and a transparent spacer layer is disposed between the touch control electrode and the strip-shaped electrodes.

2. The 3D touch control liquid crystal lens grating claimed as claim 1, wherein at edges on opposite sides of the plane electrode and a region where the strip-shaped electrodes are located, there are identical patterns formed through the same mask which includes an external pin bonding part and an alignment mark.

3. The 3D touch control liquid crystal lens grating claimed as claim 1, wherein the at least one touch control electrode adopts an internal wire to gather a touch control signal.

4. The 3D touch control liquid crystal lens grating claimed as claim 1, wherein the transparent spacer layer is of a transparent insulating material or of a transparent resistance material.

5. The 3D touch control liquid crystal lens grating claimed as claim 1, wherein the at least one touch control electrode takes the form of a rectangle, and a long side of the at least one touch control electrode is less than or equal to 6 millimeters.

6. The 3D touch control liquid crystal lens grating claimed as claim 1, wherein the at least one touch control electrode takes the form of a circle, trapezoid, diamond, or the like.

7. The 3D touch control liquid crystal lens grating claimed as claim 1, wherein the upper transparent substrate and the lower transparent substrate are glass substrates or plastic substrates.

8. The 3D touch control liquid crystal lens grating claimed as claim 1, wherein there are two or more the touch control electrodes, and a gap is formed between any two adjacent touch control electrodes.

9. A 3D touch control display device, comprising:
a display panel; and
a liquid crystal lens grating, adhered to a light emitting side of the display panel, which is the liquid crystal lens grating claimed as claim 1, wherein the upper substrate with the strip-shaped electrodes formed is farther from the display panel compared to the lower substrate with the plane electrode formed.

10. The 3D touch control display device claimed as claim 9, wherein the display panel is a LCD display panel, an organic electroluminescence (OLED) display panel or an electronic paper panel.

11. A manufacturing method of a 3D touch control liquid crystal lens gating, comprising:
forming a plane electrode on a lower transparent substrate, so as to obtain a lower substrate;
sequentially forming at least one touch control electrode, a transparent spacer layer and strip-shaped electrodes on an upper transparent substrate, so as to obtain an upper substrate; and
cell-assembling the upper substrate with the lower substrate to form a cell, and filling liquid crystal in the cell, so as to form the liquid crystal lens grating.

12. The manufacturing method claimed as claim 11, wherein at edges on opposite sides of the plane electrode and a region where the strip-shaped electrodes are located, there are identical patterns formed through the same mask which include an external pin bonding part and an alignment mark.

13. The manufacturing method claimed as claim 11, wherein the at least one touch control electrode adopts an internal wire to gather a touch control signal.

14. The manufacturing method claimed as claim 11, wherein the transparent spacer layer is of a transparent insulating material or of a transparent resistance material.

15. The manufacturing method claimed as claim 11, wherein, the at least one touch control electrode takes the form of a rectangle, and a long side of the at least one touch control electrode is less than or equal to 6 millimeters.

16. The manufacturing method claimed as claim 11, wherein over the plane electrode and the strip-shaped electrodes, there are further formed liquid crystal alignment film layers.
